(19) United States
(12) Patent Application Publication
(10) Pub. No.: US 2006/0151087 A1
(43) Pub. Date: Jul. 13, 2006

(54) Apparatus and method for punching cover layers for optical disks and apparatus and method for laminating the cover layers

(75) Inventor: Akira Mizuta, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/316,806

(22) Filed: Dec. 27, 2005

(30) Foreign Application Priority Data
Jan. 7, 2005 (JP) P.2005-2660

(51) Int. Cl. B32B 37/00; B32B 38/00; B32B 38/04

(52) U.S. Cl. 156/64; 156/256; 156/379; 156/539; 156/540; 156/542; 156/556

(57) ABSTRACT

Cover layers for protecting recording layers of optical disks respectively are produced by that when the cover layers are punched out in a cover sheet, defects in the cover layers are inspected by an inspection means provided on at least one of upstream and downstream sides of a punching portion where each cover layer is punched out in the fed cover sheet, and defective cover layers detected by the inspection means are separated from non-defective cover layers and collected into a defective product collection portion.

### FIELD OF THE INVENTION

The present invention relates to a punching apparatus and method for punching out cover layers in a cover sheet and a laminating apparatus and method for laminating the cover layers onto disk substrates respectively.

### BACKGROUND OF THE INVENTION

Optical disks such as CD (compact disc), CD-R (compact disc-recordable), DVD (digital versatile disc) DVD-R (digital versatile disc-recordable), etc. have heretofore come into wide use.

Examination of high-density information recording in an optical disk has advanced in recent years in accordance with the demand for storage of a larger quantity of information such as video information. The information recording density of the optical disk chiefly depends on the size of a light beam spot on the disk. The spot size is proportional to λ/NA in which λ is the wavelength of the laser beam, and NA is the numerical aperture of an objective lens. For this reason, increase in NA of the objective lens is effective while reduction in wavelength of the laser beam is required for increasing the recording density of the optical disk. Because coma aberration caused by inclination of the optical disk is in proportion to the cube of the NA, the margin for the inclination due to tilting, etc. of the disk however becomes very small in accordance with increase in the NA. Even when the disk is inclined slightly, the beam spot is blurred so that it is impossible to record and reproduce information with high density. Therefore, in a background-art optical disk suitable for higher density recording, a sufficiently thin (e.g. about 0.1 mm thick) cover layer is provided on a disk substrate so that the cover layer serves as a laser beam-transmissive layer in order to suppress increase of the coma aberration caused by inclination of the disk with increase in the NA.

In a line for production of such optical disks, there is an apparatus for performing a process in which each of cover layers made of a thin-film rein is processed so as to be half-removed from a cover sheet into a predetermined shape so that the cover layers are one by one removed from the cover sheet and laminated onto recording layers of disk substrates which have the recording layers formed in advance (e.g. see JP-A-2004-134020).

### SUMMARY OF THE INVENTION

There is still room for improvement in the aforementioned background-art apparatus at the following points.

(1) Although the cover sheet is produced in such a manner that films are laminated before the laminating process, there is a possibility that the cover sheet may be contaminated with dust or air bubbles entering between the films when the cover sheet is produced. When such a defective cover sheet is laminated onto a disk substrate to produce an optical disk, it is impossible to produce any non-defective optical disk because of the defect in the cover sheet. As a result, lowering of yield rate is inevitable.

(2) In the laminating process, the cover sheet stopped in a punching position is left in a state in which the cover sheet is deformed by a punching die when the cover sheet is stopped for a long time because of emergency stop or the like. In this case, an unused portion near the outer circumferences of the cover layers inhibits deformation caused by punching from being repaired if the unused portion is not removed rapidly. When the laminating process is then restarted, air bubbles are generated in lamination of the cover sheet onto the disk substrate because of the deformation of the cover sheet. The air bubbles cause defects in external appearance, so that there is a disadvantage in that non-defective optical disks cannot be produced.

In the background-art laminating process, even in the case where defects occur in sheets to be laminated for the aforementioned reason, the defects are inspected after the defective sheets together with non-defective sheets are laminated onto disk substrates in a production line to produce optical disks. Accordingly, the same cost as that for laminating the non-defective sheets is taken for laminating the defective sheets. There is still room for improvement.

The invention is accomplished upon such circumstances. An object of the invention is to provide a punching apparatus and method and a laminating apparatus and method in which defective cover layers are separated from non-defective cover layers in advance so as not to be subjected to a laminating process so that non-defective optical disks can be produced.

The foregoing object can be achieved by the following configuration:

(1) A punching apparatus for punching out cover layers in a cover sheet to form the cover layers for protecting recording layers of optical disks respectively, including: a sheet supply portion for supplying the cover sheet; a punching portion for punching out the cover layers in the cover sheet; and a transport device for conveying the punched cover layers, wherein the punching apparatus further includes: an inspection means provided on at least one of upstream and downstream sides of the punching portion with respect to a direction of conveyance of the cover sheet; and a defective product collection portion for separating defective cover layers detected by the inspection means from non-defective cover layers so that the defective cover layers are collected in the detective product collection portion by the transport device.

(2) A punching apparatus according to the paragraph (1), further including: a removal portion for removing a releasable portion near outer circumferences of the cover layers from the cover sheet; and a controller for controlling the transport device to convey each cover layer between the removal portion and the punching portion to the defective product collection portion when punching of the cover sheet in the punching portion is stopped for a predetermined time.

(3) A punching method for punching out cover layers in a supplied cover sheet to form the cover layers for protecting recording layers of optical disks respectively, including the steps of: punching out the cover layers in the cover sheet by a punching portion; inspecting defects in the cover layers by an inspection means provided on at least one of upstream and downstream sides of the punching portion; and separating defective cover layers detected by the inspection means from non-defective cover layers so that the defective cover layers are collected into a defective product collection portion.

(4) A punching method according to the paragraph (3), further including the step of: conveying each cover layer between a removal portion and the punching portion to the defective product collection portion when punching of the cover sheet in the punching portion is stopped for a predetermined time, the removal portion being provided for removing a releasable portion near outer circumferences of the cover layers from the cover sheet.

(5) A laminating apparatus for laminating cover layers onto recording layers formed on disk substrates respectively, including: a punching apparatus defined in the paragraph (1) or (2); a substrate supply portion for supplying the disk substrates; and a laminating portion for laminating the cover layers onto the disk substrates respectively, wherein the cover layers except defective cover layers detected by the punching apparatus are laminated onto the disk substrates respectively by the laminating apparatus.

(6) A laminating method for laminating cover layers onto disk substrates in order to protect recording layers of optical disks respectively, including the steps of: inspecting defects in the cover layers by an inspection means provided on at least one of upstream and downstream sides of a punching portion in which each of the cover layers is punched out in the cover sheet (inspection step); separating detected defective cover layers from non-defective cover layers so that the defective cover layers are collected (collection step); and laminating the cover layers except the detected defective cover layers onto the disk substrates respectively (lamination step).

(7) A laminating method according to the paragraph (6) further including the step of: conveying each cover layer between a removal portion and the punching portion into a defective product collection portion by a transport device when punching of the cover sheet in the punching portion is stopped for a predetermined time, the removal portion being provided for removing a releasable portion near outer circumferences of the cover layers from the cover sheet.

(8) A laminating apparatus for laminating cover layers onto recording layers formed on disk substrates respectively, including: a substrate supply portion for supplying the disk substrates; a sheet supply portion for supplying a cover sheet having the cover layers half-removed; a transport device for conveying the cover layers removed from the cover sheet; and a laminating portion for laminating the cover layers conveyed by the transport device onto the disk substrates respectively, wherein the laminating apparatus further includes: an inspection means for inspecting defects in the cover layers before each cover layer is conveyed by the transport device; and a detective product collection portion for separating defective cover layers detected by the inspection means from non-defective cover layers so that the defective cover layers are collected in the detective product collection portion by the transport device.

According to the invention, defects in the cover layers are detected by the inspection means before and after each cover layer is punched out in the cover sheet or before each cover layer half-removed is removed from the cover sheet. Defective cover layers are separated from non-defective cover layers and collected as defective products. In this manner, defective cover layers contaminated with dust or air bubbles can be detected so that the defective cover layers can be prevented from being laminated onto disk substrates in post-processing. For this reason, after defective cover layers which apparently make it difficult to obtain good optical disks by laminating the defective cover layers onto disk substrates respectively are collected and removed in advance, only non-defective cover layers can be laminated onto disk substrates respectively. Accordingly, efficiency in production of optical disks can be improved, so that yield rate can be improved.

Because each cover layer between the removal portion and the punching portion is conveyed to the defective product collection portion by the transport device when punching of the cover sheet in the punching portion is stopped for a predetermined time, the sheet deformed by a punching die in the stop period can be prevented from being laminated onto the disk substrate in post-processing. Accordingly, optical disks having defects in external appearance can be prevented from being produced.

According to the invention, it is possible to provide a punching apparatus and method and a laminating apparatus and method in which defective cover layers can be separated from non-defective cover layers so as not to be subjected to a laminating process so that non-defective optical disks can be produced.

### BRIEF DESCRIPTION OF THE DRAWINGS

FIG. 1 is a view, partly in enlarged section, showing an optical disk produced by an optical disk laminating apparatus.

FIG. 2 is a view showing an optical disk laminating apparatus.

FIG. 3 is a view for explaining a procedure for producing cover layers.

FIG. 4 is a view showing another example of a cover sheet.

FIG. 5 is a view showing a transport device.

FIG. 6 is a view for explaining a state in which a cover layer and a disk substrate are held.

FIG. 7 is a view showing part of a laminating apparatus according to a first embodiment of the invention.

FIG. 8 is a view showing part of a laminating apparatus according to a second embodiment of the invention.

FIG. 9 is a view showing a process of applying half-removal processing to the cover sheet in advance.

FIGS. 10A and 10B are views showing another punching method in the half-removal processing portion depicted in FIG. 9.

### DESCRIPTION OF REFERENCE NUMERALS AND SYMBOLS

1: optical disk

2: disk substrate

3: cover layer

4: recording layer

10: optical disk laminating apparatus

12: punching portion

40: punching apparatus

42: inspector (inspection means)

48: transport device

49: defective product collection portion

CS: cover sheet

### DETAILED DESCRIPTION OF THE INVENTION

First, a first embodiment of the invention will be described below in detail with reference to the drawings.

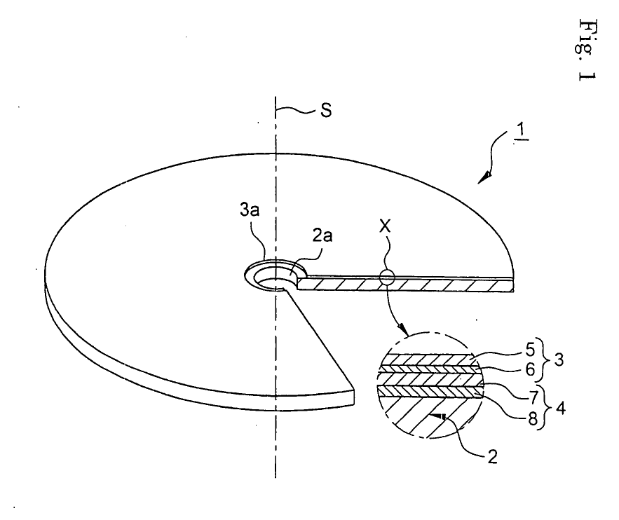

FIG. 1 is a view, partly in enlarged section, showing an optical disk produced by an optical disk laminating apparatus according to this embodiment.

The optical disk 1 permits information recording with higher density than a background-art DVD. When, for example, the numerical aperture NA of an objective lens of a disk drive device is increased to about 0.85 while a blue-violet laser beam with a short wavelength is used as a recording/reproducing laser beam, the single-side recording capacity of the optical disk 1 with a diameter of 12 cm can be increased to about 27 gigabytes compared with an optical disk according to the background art.

The optical disk 1 has a disk substrate 2 shaped like a discus. As shown in the enlarged section of a portion X in FIG. 1, an information recording layer 4 and a cover layer 3 are laminated successively on a single surface of the disk substrate 2 so that the recording layer 4 is covered with the cover layer 3.

The recording layer 4 is formed in such a manner that a light reflecting layer 8 and a light absorbing layer 7 are laminated successively on the disk substrate 2. The cover layer 3 has a tacky film 6 formed as a single surface of the cover layer 3, and a resin film 5 laminated on the recording layer 4 through the tacky film 6 so as to serve as a light-transmissive protective layer.

The disk substrate 2 is molded out of a resin such as polycarbonate. For example, the resin film 5 of the cover layer 3 is made of polycarbonate, TAC, PMMA (polymethyl methacrylate) or the like whereas the tacky film 6 of the cover layer 3 is made of a tackifier (inclusive of a photosetting resin adhesive agent) such as an acrylic tackifier, a rubber tackifier or a silicon tackifier. Especially, the acrylic tackifier is preferably used as the material of the tacky film 6 in terms of transparency and durability.

In this embodiment, the thickness of the cover layer 3, inclusive of the thickness of the tacky film and the adhesive agent, in the optical disk 1 can be set to be in a range of from 95 μm to 105 μm. The thickness of the resin film 5 can be set to be in a range of from 10 μm to 100 μm. The thickness of the tacky film and the adhesive agent can be set to be in a range of from 5 μm to 30 μm.

A center hole 2a, which is shaped like a circle with a center axis S of rotation of the optical disk 1 as its center, is provided in the central portion of the disk substrate 2. A hole 3a, which is shaped like a circle with the axis S as its center and with a diameter larger than the diameter of the center hole 2a, is formed in the central portion of the cover layer 3.

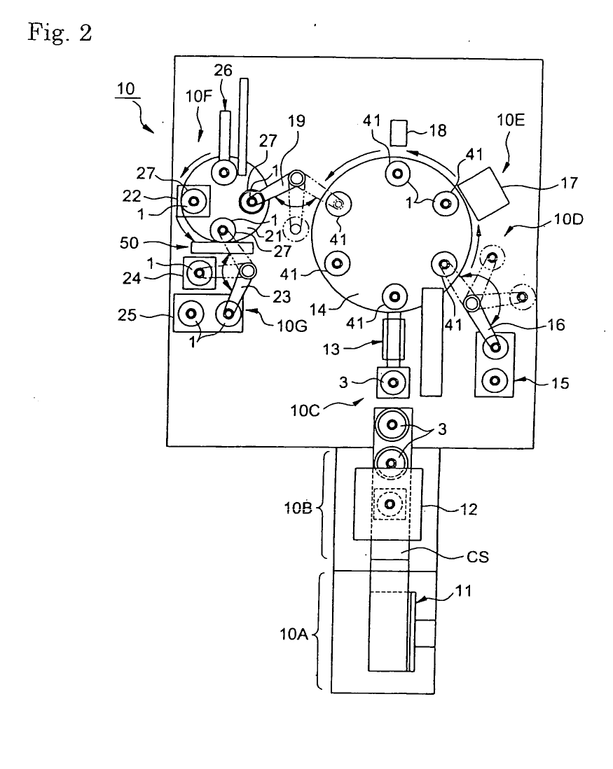

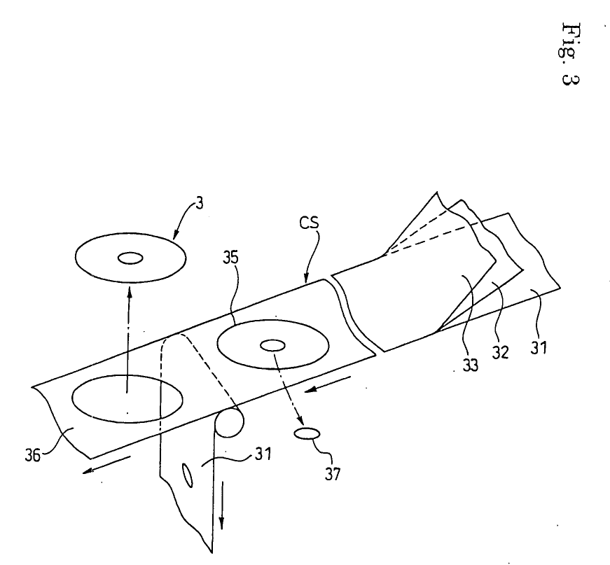

FIG. 2 is a view showing an optical disk laminating apparatus. FIG. 3 is a view for explaining a procedure for producing the cover layer. FIG. 7 is a view showing part of the laminating apparatus according to this embodiment.

The optical disk laminating apparatus 10 performs a laminating process for laminating a cover layer 3 onto each disk substrate 2 having a recording layer laminated thereon, in a line for production of the optical disk 1.

In this embodiment, after a process of producing the disk substrate 2 and a process of producing the cover layer 3 are performed independently, a process of laminating the cover layer 3 onto the disk substrate 2 having the recording layer 4 laminated thereon is performed by the optical disk laminating apparatus 10.

As shown in FIG. 3, each cover layer 3 is produced by processing a laminated sheet material (hereinafter referred to as “cover sheet CS”) which has a long belt-shaped resin film 32, a release sheet 31 stuck onto a tacky film formed on a single (lower side in FIG. 3) surface of the resin film 32, and a protective sheet 33 stuck onto the other surface of the resin film 32 opposite to the surface where the tacky film is formed.

First, the configuration of the optical disk laminating apparatus will be described.

The cover sheet CS is loaded into a sheet feeder portion 11 of a supply portion 10A in the condition that the cover sheet CS is rolled up. At the time of production, the cover sheet CS is fed out from the sheet feeder portion 11.

As shown in FIG. 2, the cover sheet CS fed out from the sheet feeder portion 11 is conveyed to a punching process portion 10B. The protective sheet 33 and the resin film 32 are punched out in the cover sheet CS by a ring-like punching die which is not shown but provided in a punching portion 12. Thus, a circular punched region 35 is formed as shown in FIG. 3. Incidentally, in the embodiment, the release sheet 31 of the cover sheet CS is not punched out at the time of punching, so that the release sheet 31 serves as a carrier for holding and conveying the punched region 35 punched out in the cover sheet CS.

As shown in FIG. 3, after the cover sheet CS is punched in the punching process portion 10B (see FIG. 2), the cover sheet CS is conveyed to a cover layer takeout portion 10C. Circular cover layers 3 parted by the punched regions 35 are taken out successively. On the other hand, an unnecessary portion 36 which is a region except the punched regions 35 of the resin film 32, and the release sheet 31 are collected respectively. Specifically, as shown in FIG. 7, after the cover layers 3 on a punching stage 54 are punched by the punching portion 12, dust in the center holes of the punched regions 35 is temporarily held in a sheet. The cover layers 3 are then extracted and collected by a collection portion 45. The unnecessary portion 36 is first removed from the cover sheet CS by a first removal portion 46 provided on the upstream side of the cover sheet CS and is taken up by an unnecessary portion take-up portion 61. Then, the release sheet 31 is removed by a second removal portion 47 provided on the downstream side of the first removal portion 46 and is taken up by a base film take-up portion 62 while each cover layer 3 is disposed on a transport device 48. The cover layer 3 taken out from the cover layer takeout portion 10C is conveyed by the transport device 48 as will be described later.

The shape of the cover sheet CS is not limited to the aforementioned case where the whole portion except the cover layers 3 is removed. Only a portion adjacent to the outer circumference of each cover layer 3 may be removed as a releasable portion.

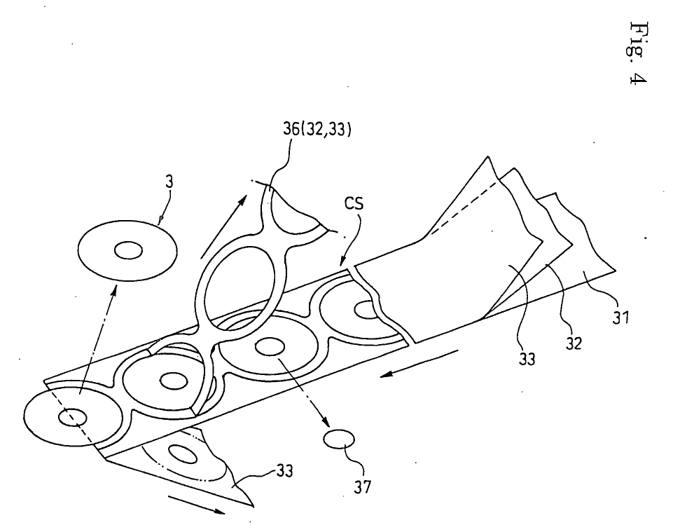

FIG. 4 is a view showing another example of the cover sheet CS. As shown in FIG. 4, an unnecessary portion 36 adjacent to the outer circumference of the cover layers 3 may be removed as a releasable portion from the release sheet 31 while the cover layers 3 and the other regions than the unnecessary portion 36 remain on a front surface of the release sheet 31. According to this measure, a mark caused by the thickness of the cover layers 3 can be prevented from being left on the cover sheet CS when the cover sheet CS is wound up and preserved as a roll of sheet.

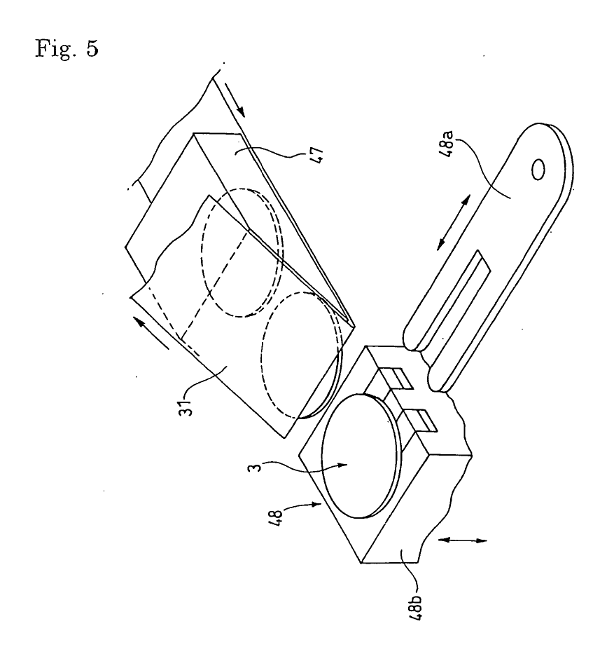

The cover layers 3 are conveyed to a disc-like first turntable 14 by the transport device 48 as shown in FIG. 5 and transferred onto support stages 41 provided at regular circumferential intervals on the first turntable 14. The transport device 48 has a transport portion 48a for transporting the cover layers 3 while supporting the cover layers 3 from the lower side, and a holding stage 48b for holding the cover layers 3 before the cover layers 3 are supported by the transport portion 48a. The first turntable 14 is configured so that the circumferential rotation of the first turntable 14 is controlled, for example, as represented by arrows in FIG. 2, to change the circumferential position of the first turntable 14 to thereby change the respective positions of the support stages 41.

In the optical disk laminating apparatus 10 according to this embodiment, a substrate supply portion 10D, a laminating process portion 10E and a substrate inverter 18 are provided successively along the circumference of the first turntable 14 and in the direction of rotation of the first turntable 14.

The substrate supply portion 10D has a substrate feeder 15 for holding disk substrates 2 having recording layers 4 formed by another process. The substrate supply portion 10D is configured so that the disk substrates 2 held in the substrate feeder 15 are one by one grasped by a rotary arm 16, conveyed to the support stages 41 of the first turntable 14 and disposed on the support stages 41 respectively.

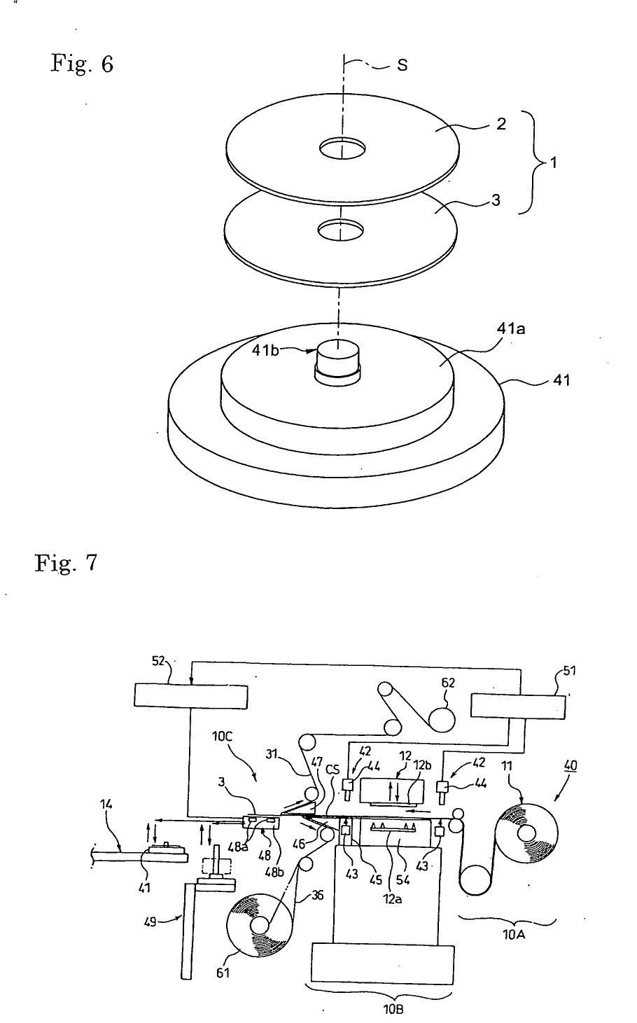

When a cover layer 3 is to be disposed on each of the support stages 41 of the first turntable 14, the cover layer 3 is held while positioned on the support stage 41 in such a manner that a center pin 41b protruded from the support stage 41 is inserted in the hole 3a of the cover layer 3 in the direction of the shaft S as shown in FIG. 6 while the tacky film 6 (see FIG. 1) of the cover layer 3 is turned upward.

After the cover layer 3 is supported by the support stage 41, a disk substrate 2 is conveyed above the support stage 41 while grasped by the rotary arm 16. Then, in the condition that the recording layer 4 (see FIG. 1) is turned downward, the center pin is inserted in the center hole 2a of the disk substrate 2 so that the disk substrate 2 is temporarily held while kept separate from the cover layer 3.

When the first turntable 14 is then rotated, the support stage 41 supporting the disk substrate 2 and the cover layer 3 is conveyed to the laminating process portion 10E. A laminating portion 17 is provided in the laminating process portion 10E. The laminating portion 17 has an airtight chamber (not shown) kept in a vacuum. When the center pin of the support stage 41 is driven in the condition that the support stage 41 is put in the airtight chamber, the disk substrate 2 held by the center pin is laminated onto the cover layer 3 supported on the lower side, through the tacky film 6. Then, the disk substrate 2 and the cover layer 3 are pressed by a laminating plate from above to complete lamination.

The optical disk 1 obtained thus is conveyed to the substrate inverter 18 in accordance with the rotation of the first turntable 14 and inverted by the substrate inverter 18, so that the cover layer 3 and the disk substrate 2 disposed on the support stage 41 are turned upside down. In this manner, the optical disk 1 is disposed in the condition that the cover layer 3 is exposed upward.

After inverted by the substrate inverter 18, each optical disk 1 is moved with rotation of the first turntable 14, grasped by a rotary arm 19 and conveyed to a post-processing portion 10F. In the post-processing portion 10F, the optical disks 1 are disposed on support stages 27 provided at regular circumferential intervals on a second turntable 21 shaped like a discus. The second turntable 21 has basically the same mechanism as the first turntable 14. The second turntable 21 is configured so that the respective positions of the support stages 27 can be changed by circumferential rotation control of the second turntable 21 as represented by arrows in FIG. 2.

A protective sheet remover 26, a surface inspector 22 and static eliminators 50 are provided successively along the circumference of the second turntable 21 and in the direction of rotation of the second turntable 21.

The protective sheet remover 26 performs a process of removing the protective sheet 33 (see FIG. 3) stuck to the front surface of the cover layer 3 of each optical disk 1. After removal of the protective sheet 33, the optical disk 1 is conveyed to the surface inspector 22 in accordance with the rotation of the second turntable 21.

The surface inspector 22 inspects the front surfaces of the recording layer 4 and the cover layer 3 of the optical disk 1. In this manner, a defective optical disk 1 such as an optical disk having a cover layer 3 contaminated with dust or air bubbles or an optical disk having a warped substrate can be detected.

A good optical disk 1 having no defect detected by the surface inspection is then conveyed to an accumulation portion 10G and collected in a good disk accumulation portion 25. On the other hand, an optical disk 1 having any defect detected by the surface inspection is conveyed from the second turntable 21 and then collected in a defective disk accumulation portion 24 while separated from the non-defective optical disk 1.

The static eliminators 50 are provided for eliminating static electricity from the electrostatically charged optical disk 1 after the optical disk 1 is inspected by the surface inspector 22 and before the optical disk 1 is conveyed to the accumulation portion 10G.

Next, the configuration and process for detecting a defect in the cover layer in the laminating apparatus according to this embodiment will be described with reference to FIG. 7.

The cover sheet CS fed from the sheet feeder portion 11 is conveyed to the punching process portion 10B and supported by the punching stage 54. In the condition that a cutter 12a in the punching portion 12 is fixed on a lower side, a receiving portion 12b fixed on an upper side is driven to move up and down to press the cover sheet CS from above to thereby perform punching. Inspectors 42 are provided on the upstream and downstream sides of the punching portion 12 with respect to the direction of conveyance of the cover sheet CS so that the inspectors 42 serve as inspecting means.

Each inspector 42 has a radiation portion 43 for applying detection light on a lower surface side of the conveyed cover sheet CS, and a photo detection portion 44 for detecting light applied from the radiation portion 43. The photo detection portion 44 is disposed on an upper surface side of the cover sheet CS so as to be opposite to the radiation portion 43 with respect to the cover sheet CS. In this embodiment, the inspector 42 is configured so that the photo detection portion 44 detects a place of the cover sheet CS where light is applied by the radiation portion 43, that is, the photo detection portion 44 detects change in intensity of applied light in a portion contaminated with dust or air bubbles to thereby detect defects.

The inspectors 42 are connected to a controller 51. When defects are detected, the inspectors 42 send out defect signals to the controller 51.

A transport device drive portion 52 is connected to the transport device 48. The controller 51 is connected to the transport device drive portion 52. Upon reception of a defect signal from any one of the inspectors 42, the controller 51 performs control to specify a defective cover layer 3, separate the defective cover layer 3 from non-defective cover layers 3 and convey the defective cover layer 3 to a defective product collection portion 49 when the defective cover layer 3 is conveyed by the transport device 48.

The defective product collection portion 49 is provided near the first turntable 14 in a driving direction of a transport portion 48a of the transport device 48. For collection of a defective cover layer 3, the controller 51 controls the transport device drive portion 52 to move the transport device 48 to the defective product collection portion 49 and move down the transport device 48 from above the defective product collection portion 49. As a result, the defective cover layer 3 held on the transport portion 48a is transferred to the defective product collection portion 49. When no defect is detected in a cover layer 3, the cover layer 3 is conveyed to above corresponding one of the support stages 41 of the first turntable 14 by the transport portion 48a and then moved down. As a result, the cover layer 3 held on the transport portion 48a is transferred to the support stage 41.

Although it is most preferable that the inspector 42 is provided on the downstream side of the punching portion 12, the inspector 42 may be provided on at least one of the upstream and downstream sides of the punching portion 12 so as to be effective in detecting defects in the cover layers 3.

The inspector 42 is not limited to the aforementioned configuration. For example, an inspector of the type using an LED, a fluorescent light source or a fiber light source for detecting foreign matter by a linear CCD photo acceptance device may be used as a transmission type inspector. Or an inspector of the type using a photo diode or the like for detecting change in light intensity by scanning laser light may be used as a reflection type inspector.

According to the laminating apparatus 10, defects in the cover layers 3 are detected by the inspectors 42 before and after each cover layer is punched out in the cover sheet CS. Defective cover layers 3 are separated from non-defective cover layers 3 and collected as defective products. In this manner, defective cover layers 3 contaminated with dust or air bubbles can be detected, so that the defective cover layers 3 are not laminated onto disk substrates 2 in post-processing. For this reason, after defective cover layers which apparently make it difficult to obtain good optical disks by lamination of the defective cover layers onto disk substrates 2 respectively are collected and removed, non-defective cover layers can be laminated onto disk substrates 2 respectively. Accordingly, efficiency in production of optical disks 1 can be improved, so that yield rate can be improved.

In the laminating apparatus 10 according to this embodiment, a laminating method according to the invention can be carried out preferably. That is, the laminating method according to the invention includes the steps of: inspecting defects in cover layers 3 by an inspector 42 provided on at least one of upstream and downstream sides of a punching portion 12 in which each of the cover layers 3 is punched out in a supplied cover sheet CS (inspection step); separating defective cover layers 3 from non-defective cover layers 3 and collecting the defective cover layers 3 (collection step); and laminating the non-defective cover layers 3 onto disk substrates 2 respectively lamination step).

The laminating apparatus 10 according to this embodiment may be provided with a punching apparatus 40 as shown in FIG. 7. That is, the punching apparatus 40 includes: a supply portion 11 for supplying a cover sheet CS; a punching portion 12 for punching out cover layers 3 in the cover sheet CS; and a transport portion 48a for conveying the punched cover layers 3. In the punching apparatus 40, an inspector 42 is provided on at least one of upstream and downstream sides of the punching portion 12 in a direction of conveyance of the cover sheet CS. A detective product collection portion 49 is provided so that defective cover layers 3 detected by the inspector 42 are separated from non-defective cover layers 3 and collected in the detective product collection portion 49 by a transport portion 48a. According to the punching apparatus 40, defective portions contaminated with dust or air bubbles can be detected in the cover layers 3, so that only non-defective cover layers can be subjected to post-processing after the defective cover layers 3 are removed. Accordingly, the yield rate of target products can be improved.

In the laminating apparatus 10 and the punching apparatus 40 according to this embodiment, it is preferable that the controller 51 performs control so that a cover layer 3 located in the punching portion 12 is conveyed to the defective product collection portion 49 by the transport portion 48a when punching of the cover sheet CS in the punching portion 12 is stopped for a predetermined time. On this occasion, a cover layer 3 stopped between the punching portion 12 and the removal portion (second removal portion 47) is regarded as a defective cover layer caused by deformation so that the defective cover layer 3 can be conveyed by the transport portion 48a and collected by the defective product collection portion 49 without any defect detection process carried out by the inspector 42. Particularly in the case of a cover sheet CS shown in FIG. 7, deformation cannot be repaired if the cover sheet CS is left for a long time without removal of the unnecessary portion 36. When the cover layer 3 stopped between the punching portion 12 and the removal portion (second removal portion 47) is removed after stopping, the sheet deformed by the punching die in the stopping period can be prevented from being laminated onto the disk substrate in post-processing. Accordingly, optical disks having defects in external appearance can be prevented from being produced.

A second embodiment of the invention will be described below.

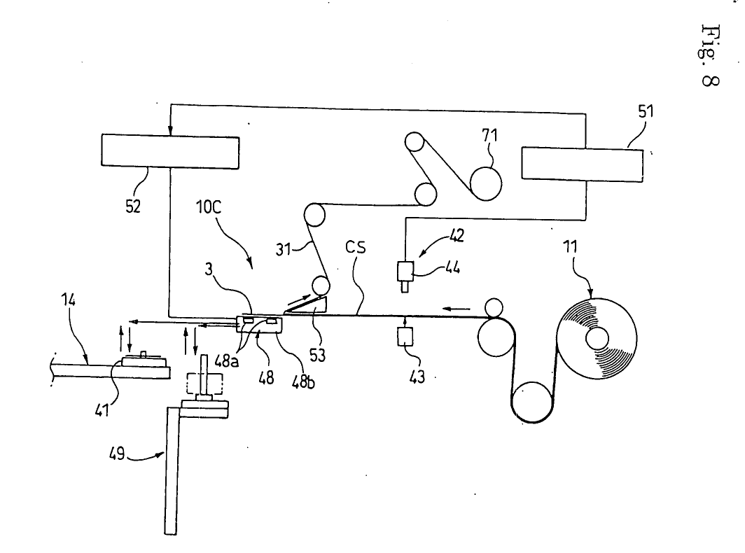

FIG. 8 is a view showing part of a laminating apparatus according to this embodiment. The basic configuration of the laminating apparatus according to this embodiment is the same as that of the aforementioned embodiment, except that a cover sheet CS having punched regions formed in advance is supplied without provision of any punching portion. Incidentally, in the following description of the embodiment, members etc. having identical configurations and effects as those members described above are denoted by the same or similar reference numerals correspondingly for the sake of simplification or omission of description.

Referring to FIG. 8, the sheet supply portion 11 supplies a cover sheet CS which is subjected to half-removal processing so that punched regions are formed in the cover sheet CS in advance.

Specifically, a procedure for applying half-removal processing to the cover sheet CS will be described.

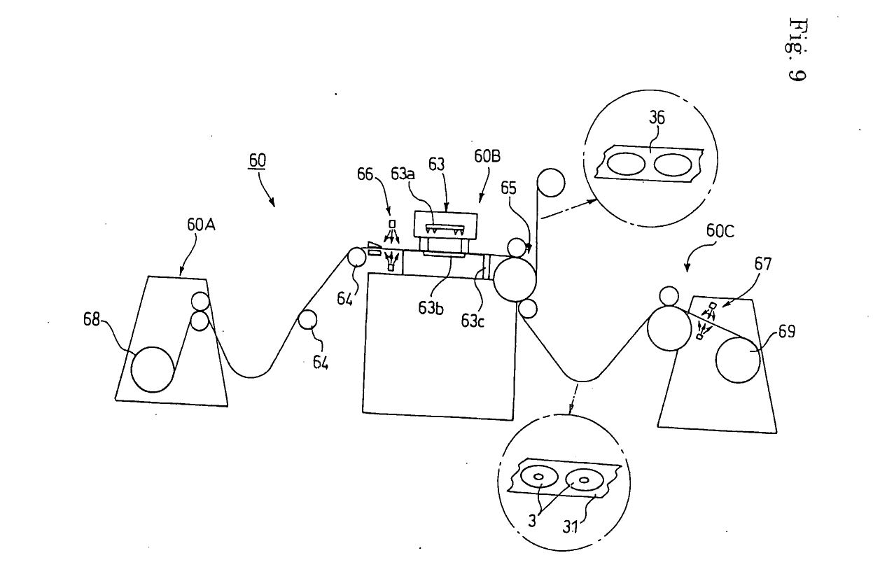

FIG. 9 is a view showing a process for applying half-removal processing to the cover sheet CS. As shown in FIG. 9, in a feed portion 60A, the cover sheet CS is fed out from a feed roll 68 wound with the cover sheet CS, and conveyed to a half-removal processing portion 63 through a conveyance roller 64. In the half-removal processing portion 63, punched regions 35 are formed in the same manner as in FIG. 3. After punching, an unnecessary portion 36 is collected in an unnecessary portion collection portion 65. The unnecessary portion 36 is removed, so that each cover layer 3 is held in the release sheet 31 while the cover sheet CS uses the release sheet 31 as a base film. The cover sheet CS is wound up on a take-up roll 69 of a take-up portion 60C to thereby produce the cover sheet CS having punched regions formed.

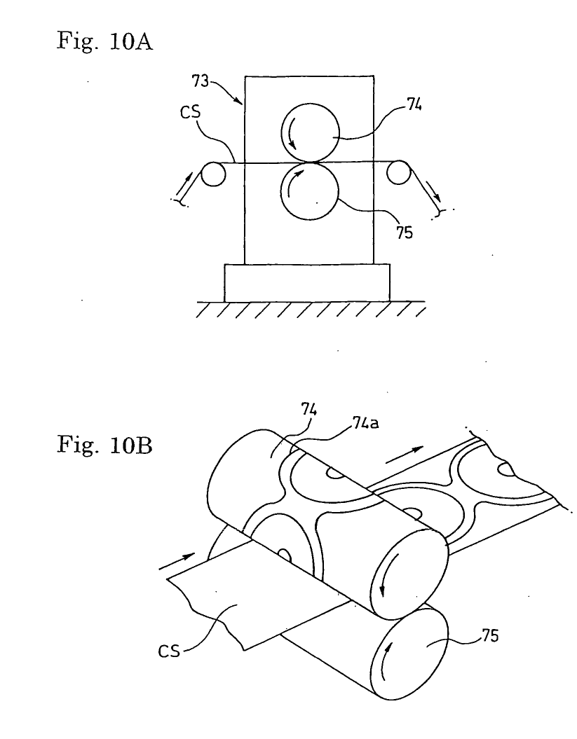

Although an intermittent punching method as represented by the half-removal processing portion 63 shown in FIG. 9 is used, a rotary die type punching method shown in FIGS. 10A and 10B may be used instead. As shown in FIGS. 10A and 10B, a rotary die type half-removal processing portion 73 has a cylindrical die 74 rotating circumferentially, and a cylindrical anvil 75 which can rotate while the cover sheet CS is clamped between the circumferential surface of the anvil 75 and the circumferential surface of the die 74. As shown in FIG. 10B, a cutter 74a for applying half-removal processing to a surface of the cover sheet CS is formed on the circumferential surface of the die 74.

A first static eliminator 66 is provided on the upstream side of the half-removal processing portion 63 in the direction of conveyance of the cover sheet CS. A second static eliminator 67 is provided on the upstream side of the take-up roll 69. Each of the first and second static eliminators 66 and 67 can be formed so that ions generated in electrodes on which a high voltage is applied are sprayed onto the cover sheet CS by an air blowing member without contact. Another configuration than the ion spraying configuration may be used. For example, a high-frequency corona discharge type (AC or DC) static eliminator, a wire type static eliminator or a feeble X-ray irradiation type static eliminator not requiring air blowing may be used as a non-contact static eliminator. A static eliminator of the type having a static eliminating brush may be used as a contact static eliminator.

As shown in FIG. 8, in the laminating apparatus and the punching apparatus according to this embodiment, the sheet supply portion 11 supplies the cover sheet CS having punched regions formed in advance. While the release sheet 31 is removed by a removal portion 53, the cover sheet CS is wound up on a base film take-up portion 71. On the other hand, the separated cover layer 3 is disposed on the transport device 48.

The transport device 48 is controlled by a transport device drive portion 52 in the same manner as in the aforementioned embodiment so that the transport device 48 is driven between the position where the cover layer 3 is disposed and the position where the cover layer 3 is transferred onto corresponding one of the support stages 41 of the first turntable 14.

An inspector 42 connected to the controller 51 is provided on the upstream side of the transport device 48 in the direction of conveyance of the cover sheet CS. The configuration of the inspector 42 in this embodiment may be the same as that of the inspector in the aforementioned embodiment.

When the inspector 42 detects a defect in a cover layer 3 of the conveyed cover sheet CS, the inspector 42 feeds a defect signal to the controller 51. The transport device drive portion 52 controls the transport device 48 to be driven. A defective cover layer 3 is conveyed to the defective product collection portion 49. A non-defective cover layer 3 is conveyed to corresponding one of the support stages 41 of the first turntable 14 by the transport device 48.

Also on this embodiment, defects in the cover layers 3 are detected by the inspector 42 before each half-removed cover layer 3 is removed from the cover sheet CS. Accordingly, defective cover layers 3 are collected as defective products. Accordingly, defective cover layers which apparently make it difficult to produce good optical disks in lamination of the defective cover layers onto disk substrates 2 respectively can be collected and removed in advance. Efficiency in production of optical disks 1 can be improved, so that yield rate can be improved.

This application is based on Japanese Patent application JP 2005-2660, filed Jan. 7, 2005, the entire content of which is hereby incorporated by reference, the same as if set forth at length.

What is claimed is:

1. A punching apparatus for punching out cover layers in a cover sheet to form the cover layers for protecting recording layers of optical disks respectively, comprising:
a sheet supply portion for supplying the cover sheet;
a punching portion for punching out the cover layers in the cover sheet; and
a transport device for conveying the punched cover layers,
wherein the punching apparatus further comprises:
an inspection means provided on at least one of upstream and downstream sides of the punching portion with respect to a direction of conveyance of the cover sheet; and
a defective product collection portion for separating defective cover layers detected by the inspection means from non-defective cover layers so that the defective cover layers are collected in the defective product collection portion by the transport device.

2. The punching apparatus according to claim 1, further comprising:
a removal portion for removing a releasable portion near outer circumferences of the cover layers from the cover sheet; and
a controller for controlling the transport device to convey each cover layer between the removal portion and the punching portion to the defective product collection portion when punching of the cover sheet in the punching portion is stopped for a predetermined time.

3. A punching method for punching out cover layers in a supplied cover sheet to form the cover layers for protecting recording layers of optical disks respectively, the method comprising:
punching out the cover layers in the cover sheet by a punching portion;
inspecting defects in the cover layers by an inspection means provided on at least one of upstream and downstream sides of the punching portion; and
separating defective cover layers detected by the inspection means from non-defective cover layers so that the defective cover layers are collected into a defective product collection portion.

4. The punching method according to claim 3, further comprising:
conveying each cover layer between a removal portion and the punching portion to the defective product collection portion when punching of the cover sheet in the punching portion is stopped for a predetermined time, the removal portion being provided for removing a releasable portion near outer circumferences of the cover layers from the cover sheet.

5. A laminating apparatus for laminating cover layers onto recording layers formed on disk substrates respectively, comprising:
a punching apparatus defined in claim 1;
a substrate supply portion for supplying the disk substrates; and
a laminating portion for laminating the cover layers onto the disk substrates respectively, wherein the cover layers except defective cover layers detected by the punching apparatus are laminated onto the disk substrates respectively by the laminating apparatus.

6. A laminating method for laminating cover layers onto disk substrates in order to protect recording layers of optical disks respectively, the method comprising:
inspecting defects in the cover layers by an inspection means provided on at least one of upstream and downstream sides of a punching portion in which each of the cover layers is punched out in the cover sheet;
separating detected defective cover layers from non-defective cover layers so that the defective cover layers are collected; and
laminating the cover layers except the detected defective cover layers onto the disk substrates respectively.

7. The laminating method according to claim 6, further comprising:
conveying each cover layer between a removal portion and the punching portion into a defective product collection portion by a transport device when punching of the cover sheet in the punching portion is stopped for a predetermined time, the removal portion being provided for removing a releasable portion near outer circumferences of the cover layers from the cover sheet.

8. A laminating apparatus for laminating cover layers onto recording layers formed on disk substrates respectively, comprising:
a substrate supply portion for supplying the disk substrates;
a sheet supply portion for supplying a cover sheet having the cover layers half-removed;
a transport device for conveying the cover layers removed from the cover sheet; and
a laminating portion for laminating the cover layers conveyed by the transport device onto the disk substrates respectively, wherein the laminating apparatus further comprises:
an inspection means for inspecting defects in the cover layers before each cover layer is conveyed by the transport device; and
a detective product collection portion for separating defective cover layers detected by the inspection means from non-defective cover layers so that the defective cover layers are collected in the detective product collection portion by the transport device.
